(19) United States
(12) Patent Application Publication
(10) Pub. No.: US 2011/0277276 A1
(43) Pub. Date: Nov. 17, 2011

(54) CUSTOMIZABLE GARMENT ACCESSORY

(76) Inventor: Diana M. PUCCI, Bronx, NY (US)

(21) Appl. No.: 12/781,198

(22) Filed: May 17, 2010

(51) Int. Cl. F16B 2/26; H01F 7/02; A44B 99/00

(52) U.S. Cl. 24/3.3

(57) ABSTRACT

The invention relates to a customizable eye glass holder framework, as an accessory confinement device or clothing adornment device, such as a tie bar, scarf clip, tie tack, jacket pin, breast pin or brooch. More specifically, a garment accessory is provided with includes a base, an attachment structure for attaching the base to a garment and a supporting structure connected to the base for supporting one or more of ornamentation, eyewear, and additional supporting structure for supporting eyewear.

### BACKGROUND OF THE DISCLOSURE

1. Field of the Invention

The invention relates to a customizable eye glass holder framework, as an accessory confinement device or clothing adornment device, such as a tie bar, scarf clip, tie tack, jacket pin, breast pin or brooch.

2. Background

There is a need for a customizable garment accessory which can reliably attach to a garment and function to hold items such as eye glasses as well as hold a tie or other garment in place, and is also capable of being adorned with decorative items so that the accessory as a whole is functional yet pleasant to behold.

### SUMMARY OF THE EMBODIMENTS

The invention relates to a customizable eye glass holder framework, as an accessory confinement device or clothing adornment device, such as a tie bar, scarf clip, tie tack, jacket pin, breast pin or brooch. More specifically, a garment accessory is provided with a base, an attachment structure for attaching the base to a garment and a supporting structure connected to the base for supporting one or more of ornamentation, eyewear, and additional supporting structure for supporting eyewear.

### BRIEF DESCRIPTION OF THE FIGURES

Certain embodiments of the invention will be described through the use of the accompanying drawings, which are not to be considered as limiting, and in which:

FIG. 1 illustrates a rear view of a disclosed embodiment, undecorated;

FIG. 1A illustrates the embodiment of FIG. 1, including an optional eyeglass loop

FIG. 2 illustrates a rear perspective view of the embodiment of FIG. 1, undecorated;

FIG. 3 illustrates a front elevational view of the embodiment of FIG. 1, undecorated;

FIG. 4 illustrates a rear perspective view of the embodiment of FIG. 1, undecorated and without an attachment device, herein called The Main Body;

FIG. 5 illustrates a perspective end view of a latch mechanism of the embodiment of FIG. 1;

FIG. 6 illustrates a perspective end view of the garment accessory, opposing the end illustrated in FIG. 5;

FIG. 7 illustrates the spring and spring retaining bar;

FIG. 8 illustrates an exploded view of the decorator bar of the first disclosed embodiment;

FIG. 9 illustrates an alternate embodiment;

FIG. 10 illustrates a front perspective view of the embodiment illustrated in FIG. 9;

FIG. 11 illustrates a back perspective view of the embodiment illustrated in FIG. 9;

FIG. 12 illustrates a back elevational view of the embodiment illustrated in FIG. 9;

FIG. 13 illustrates another perspective view of the embodiment illustrated in FIG. 9;

FIG. 14 illustrates another perspective view of the embodiment illustrated in FIG. 9;

FIG. 15 illustrates a detail of the spring area of the embodiment illustrated in FIG. 9;

FIG. 16 illustrates an exploded view of the embodiment illustrated in FIG. 9;

FIG. 17 illustrates a further alternative embodiment;

FIG. 18 illustrates a further alternative embodiment;

FIG. 19 illustrates a further alternative embodiment;

FIG. 20 illustrates a further alternative embodiment;

FIG. 21 illustrates a bottom side of a pin used in the embodiment illustrated in FIG. 20;

FIG. 22 illustrates an additional alternative embodiment;

FIG. 23 illustrates a latch used in the embodiment of FIG. 19;

FIG. 24 illustrates a front perspective of an additional alternative embodiment;

FIG. 25 illustrates a back perspective of the embodiment of FIG. 24;

FIG. 26 illustrates an additional alternative embodiment;

FIG. 27 illustrates an attachment mechanism for an additional alternative embodiment;

FIG. 28 illustrates a modification to the structure illustrated in FIG. 27;

FIG. 29 illustrates a front perspective view of an additional alternative embodiment utilizing the structure of FIG. 27;

FIG. 30 illustrates a back perspective view of an additional alternative embodiment;

FIG. 31 illustrates a further alternative embodiment;

FIG. 32 illustrates an additional view of the embodiment of FIG. 31;

FIG. 33 illustrates an additional view of the embodiment of FIG. 31;

FIG. 34 illustrates a further alternative embodiment;

FIG. 35 illustrates the embodiment of FIG. 34 with decorations;

FIG. 36 illustrates a further alternative embodiment;

FIG. 37 illustrates a latching mechanism for an alternative embodiment;

FIG. 38 illustrates a latching piece for an alternative embodiment;

FIG. 39 illustrates a latching piece for an alternative embodiment;

FIG. 40 illustrates a further alternative embodiment;

FIG. 41 is a view of the embodiment of FIG. 1, from the inside out;

FIG. 42 is a view of the embodiment of FIG. 1, with the decoration bar decorated with glasses hanging;

FIG. 43 is a view of the embodiment of FIG. 1 with the decoration bar decorated with glasses hanging on a loop;

FIG. 44 is a view of the embodiment of FIG. 1 with the decoration bar decorated with glasses hanging;

FIG. 45 is a view of the embodiment of FIG. 1 with the decoration bar without glasses;

FIG. 46 is a view of the embodiment of FIG. 1 with the decoration bar with a loop, a decoration piece and without glasses;

FIG. 47 is a view of the embodiment of FIG. 29 with glasses, in use;

FIG. 48 is a view of the embodiment of FIG. 1 with the decoration bar with glasses, in use; and

FIG. 49 is a view of the embodiment of FIG. 1 with the decoration bar without glasses.

### DESCRIPTION OF THE EMBODIMENTS

The illustrated garment accessory is intended to be used with a men's or ladies tie/scarf. Anyone could purchase and decorate the garment accessory with nearly any article which has a receiving channel hole, or in which a receiving channel can be milled, or to which a tube can be connected and used as an attaching mechanism. The garment accessory may also be used sans decorations. If a plain look is desired, one or more polished metal tubes can be used in place of other attachable articles. There are other potential uses for the garment accessory. For example, the garment accessory could be applied to a pocket and used as an eyeglass holder.

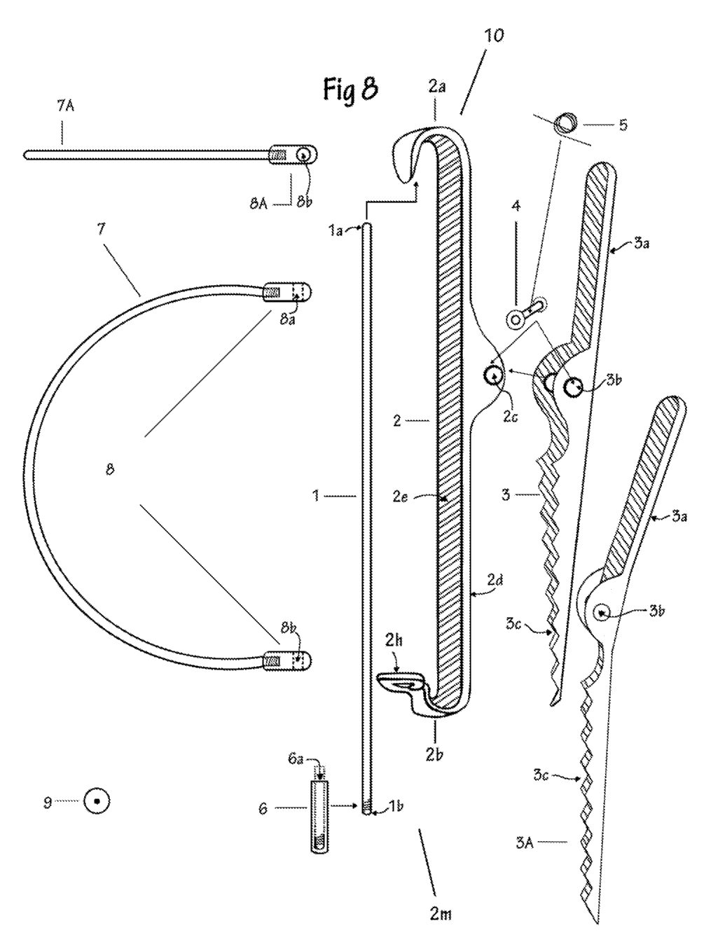

Some embodiments disclosed herein may have more or less features, depending on construction, styling and choice in findings. Various elements of one disclosed embodiment are, as illustrated in FIG. 8, the decoration bar 1, the base plate 2 and the clip 3, which form the framework, i.e., the main body 10, illustrated in FIG. 4, for one disclosed embodiment. The main body 10, illustrated in FIG. 4, allows for, effectively, unlimited customization via the manufacturing process. Customization can include the type and style of the clothing or accessory attachment device, the type and style of the elements of the main body 10, illustrated in FIG. 4, itself, and use or non-use of the eye glass holder loop 8.

The main body 10, illustrated in FIG. 4, if not overly decorated, may act as an eye glass holder. The styling of any part used to assemble the device, meaning twisted, bent, end caps vs. curled into a circle ends, decorated, off the shelf findings, customized findings can be modified within the scope of the invention.

Once manufactured, an object of the disclosed embodiments is to provide any individual, who has access to decorative objects such as beads, buttons, charms, clay of any sort, paper fabrications, metal or rubber tubing, and anything else useable as a decoration, to have a series of highly customizable frameworks to create an article of jewelry, that has one or more functions besides being decorative. One such function is that it acts as an eye glass holder, with an added function of being a tie bar/clip, a scarf clip, a breast pin or a tie tack and brooch.

All embodiments are intended as customizable jewelry as well as being functional, as eye glass holders. A customer/end user does not have to use the device to hold glasses. Utilizing the embodiments in alternative ways is within the scope of the invention.

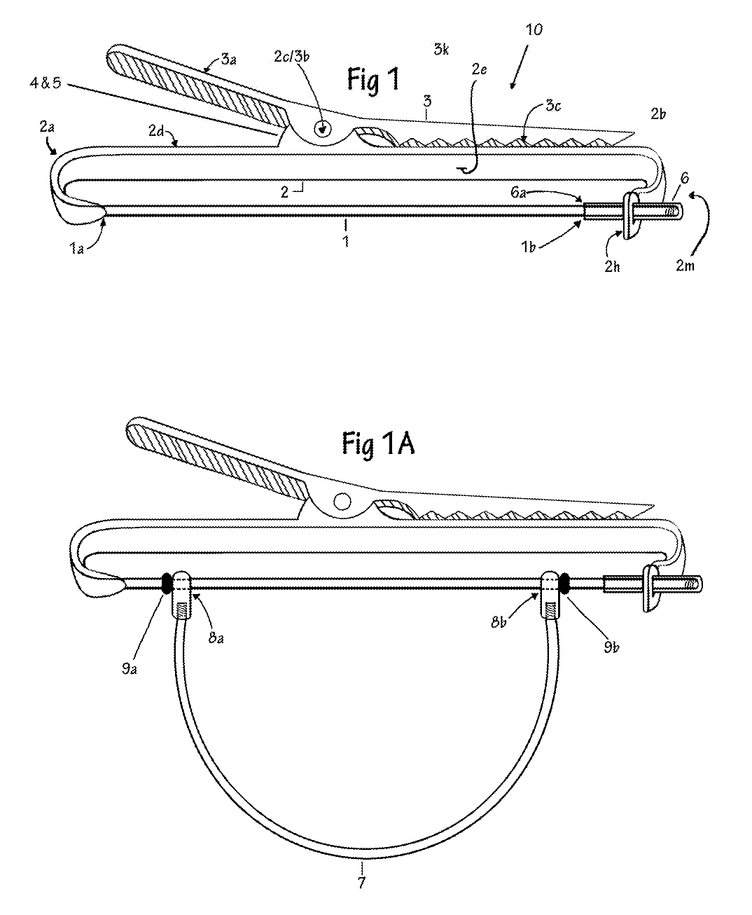

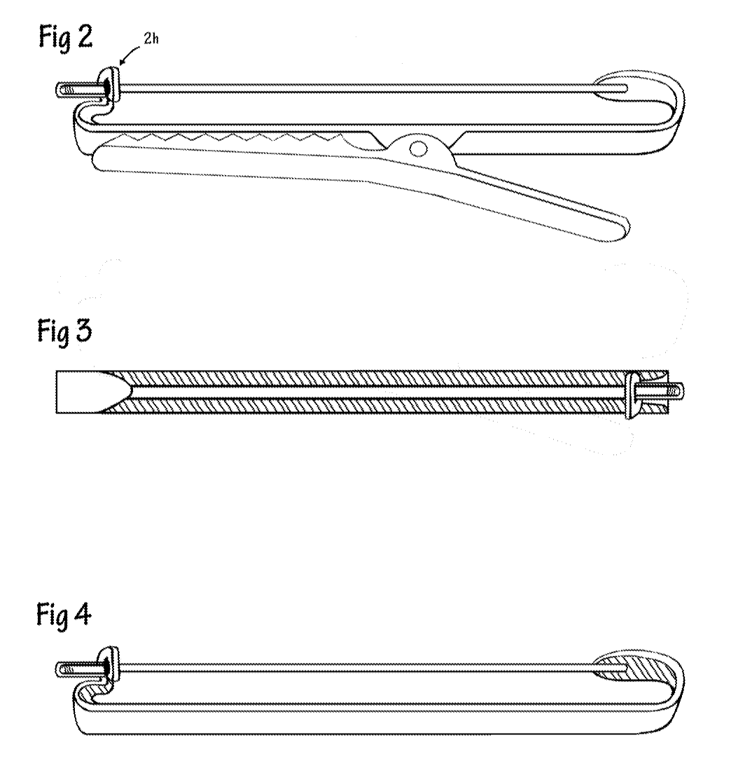

Turning to FIGS. 1-8, the purpose of the main body 10, illustrated in FIG. 4, is to retain a tie or scarf close to a shirt while providing an additional function of supporting a pair of glasses, when not being worn or not in the eyeglass case. The garment accessory keeps the eyeglasses handy when a temporary resting spot is needed. The garment accessory is not intended to replace the case as it does not provide scratch protection.

The garment accessory is designed to be customized easily by anyone. A child, with an adult's supervision, could create a special piece for his or her mom or dad. Artists, “beaders,” and jewelers will find it a valuable Finding for creating unique products for both men and women. This device is a valuable addition to any jeweler and/or Finding supply house or manufacturer.

Specific proportions of the components will change as the garment accessory is manufactured for different sizes as needed.

Turning to FIGS. 1-8, a first disclosed garment accessory embodiment is illustrated. The main body 10, illustrated in FIG. 4, includes a decoration bar 1, serving as a supporting structure, for supporting decorations and glasses. The bar 1 is, e.g., between 16 to 20 gauge wire, having a hard to extra hard characteristic, which is strong enough not to deform under normal use.

The decoration bar 1 functions as an attachment point and supporting structure for all forms of decoration, such as any kind of bead that will fit on the garment accessory, micro-electronics, mini-mechanical parts, any kind of clay decoration, cured and pierced/wrapped, etc.

The decoration bar 1 is integrally connected at one end 1a to a first, a non-latching end 2a, of a base plate 2 of the main body 10, and the bar 1 is latched at a free end 1b via a hook 2h on a latching end 2b of the base plate, where there is located a latching mechanism 2m. Between opposing ends 2a, 2b, an elongated body of the base plate 2 is long enough to seat a tie without causing the tie to crease. This length can be manufactured at different sizes, for different types of ties. The body is wide enough to support the components of the spring clip 3 disposed on its underside.

A front face 2e of the garment accessory, which opposes a rear face 2d, faces outward and when worn is usually hidden all or in part by articles being retained by the decorator bar 1, such as ties, scarves, eyeglasses, and/or ear buds for a music player.

At each opposing end 2a, and 2b of the base plate 2, the plate bends upwardly so as to form a substantial C-channel. The purpose of the C-channels is to create a connection point, for the decorator bar 1, which is appropriately spaced from the body 2e, of the base plate. The spacing is enough so that beads and other decorations can be placed on the decoration bar 1 without overly compressing a tie or garment held within the garment accessory. Opposing ends of the C-channels, spaced from the base 2e, return towards the center of the decorator bar 1 to allow a smooth appearing transition for the decorator bar 1 and, at end 2a, to provide a proper amount of weld space between the C-channel and the decorator bar 1.

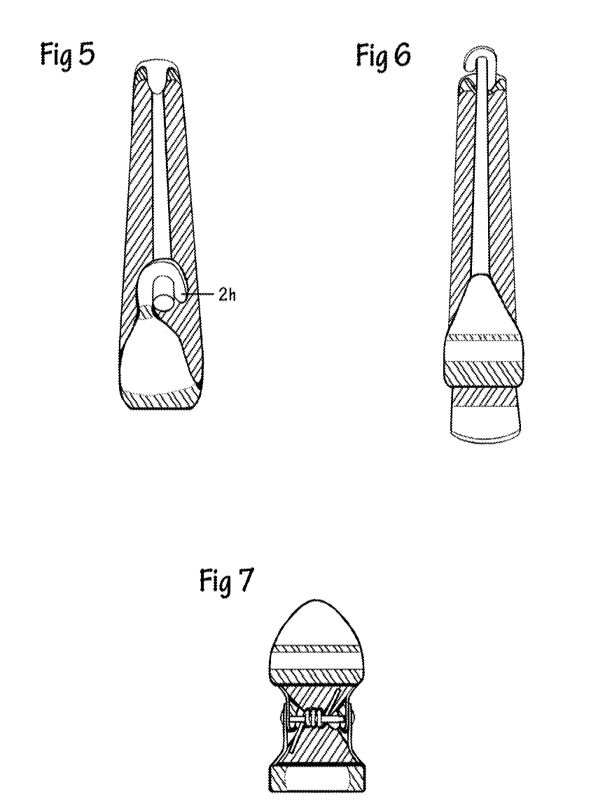

As illustrated, the hook 2h is open ended and extends substantially perpendicularly to the body 2e of the base plate 2. This enables an ease of hooking and unhooking the decorator bar 1 from the hook. As illustrated in FIG. 5, the hook direction, from the connection with the C-channel 2b, with the base plate 2 below it, is clockwise. When used on a man's shirt it curves downward and when used on a woman's shirt curves up.

The illustrated garment accessory includes a typical “crocodile” or spring clip 3 serving as an attachment device 3k for connecting to a user's shirt, lapel, etc. The clip 3 includes a griping arm with gripping teeth 3c, a lever arm/finger grip 3a and a pivot 3b, formed from a unitary piece. The clip pivot/flange with hole 3b connects with a similarly shaped base pivot/flange with hole 2c, which protrudes from the underside of the base member 2. In alternative embodiments, which use other means for gripping to clothing, other than the illustrated gripping clip 3 (illustrated below) the flange 2c is not necessary.

The gripping arm 3c is long enough so that a substantial amount of material can be clipped between the base member 2 and the gripping arm 3c, to prevent the garment accessory from twisting about a tie or garment to which it is attached. A substantially enough amount can be different for different types of ties or garments.

The lever arm 3a is bent outwardly by an angle which allows for proper opening of the gripping arm without too much depressing. However, the lever arm 3a does not protrude too far away from the front face of the bas 2e so as to skew the garment accessory away from the body of a wearer. Neither the lever arm 3a nor the gripping arm 3c extend in the longitudinal direction past the respective ends 2a, 2b of the base.

A pivot box/cylinder/spring retainer bar 4 connects the base pivot 2c to the clip pivot 3b. A tension spring 5 is wrapped about and supported by the pivot box 4 and disposed between the lever arm 3a and the backside 2d of the base member 2. The force or strength of the spring should be strong enough to provide enough holding power to keep the garment accessory in position against a shirt, to hold a tie or scarf close to body and prevent the weight of decorations and/or eyeglasses from causing the garment accessory to tilt or slide sideways.

The free end lb of the decoration bar 1 is male threaded and designed to mate with a female threaded end cap 6. The end cap 6 functions as a bead stop and design-wise balances the visual look of the base member 2. The end cap 6 causes the decoration attached to the decoration bar 1 to look centered when a symmetrical design is used. The end cap 6 mates securely to the decoration bar 1 when decorating, with ornamentation, is completed. As an alternative, the end cap can be a stick pin-type end cap, such as an earring back or keeper.

A hemispherical loop 7 which is an additional structure functioning as an eyeglass holder is provided. The material can be, e.g., 16-20 gauge wire or curved rod. The loop terminates at opposing male threaded ends 7a, 7b. At the ends 7a, 7b, opposing female threaded end caps 8a, 8b are provided. The end caps 8a, 8b are, e.g., cast in metal. The end caps 8a, 8b include eyelet loops/orifices which fit about the decorative bar 1 in the same manner as a bead.

As the end caps 8a, 8b installation is permanent, glue may be added to prevent unscrewing, though unscrewing is prevented once the loop 7 is attached to the garment accessory. Accordingly, a small amount of glue can be applied to securely fasten the screw in situations where the decoration is intended to be permanently mounted. A weaker glue can be applied when temporary mounting of the decorations is expected. Alternatively, one of the end caps 8a/b may be soldiered on or the loop 7 or formed integrally therewith. The other should be threaded to allow for enough play to fit the loop 7 over the bar 1 and allow for some decoration to be added.

Beads or some other decoration would normally keep loop 7 in position as shown in FIGS. 35, 43 and 46. Tubing of an appropriate diameter may replace beads if a plainer look is desired.

Inboard and outboard o-rings 9a/9b can be advantageously utilized. One o-ring can be positioned on either side or one can be positioned on each side of end caps 8a, 8b. When decorative beads are used as ornamentation, the o-rings keep the beads and loop 7 stationary, inboard of the outboard o-ring 9b. Alternatively, o-rings can be used when a decoration, in addition to the loop 7, are not desired, so as to keep the loop 7 stationary on the bar 1.

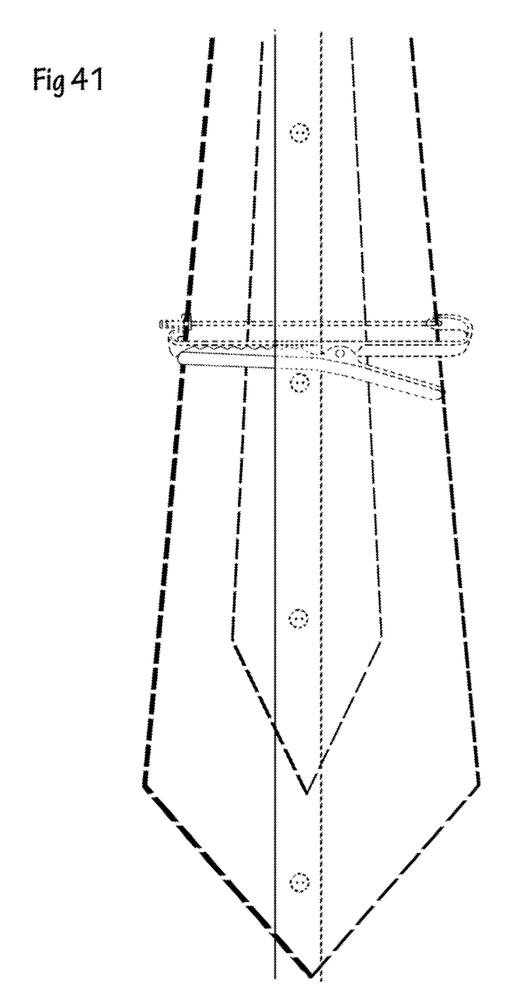

More specifically regarding FIG. 1, the components can be mostly cast formed with the long clip 3 being cast separately then attached to the main body 10?? through a fine screw or rivet 4 and tension spring 5 (e.g., a spring strong enough to hold the garment accessory so that its longitudinal axis is perpendicular to a long axis of a user's tie). The long clip 3 gives more gripping surface to allow the garment accessory more stability. FIGS. 35, 42-46 and 48-49 are decorated examples of this design in use. An example of the garment accessory in use, from an underside view against a tie, is FIG. 41.

More specifically regarding FIG. 1A, this figures illustrates essentially the same structure as FIG. 1, but illustrating how the Eye Glass optional loop 7 is installed. It illustrates plural (two to four) rubber o-rings 9 of appropriate color and size to hold the loop 7 in a central position.

FIG. 4 illustrates a rear perspective view of a disclosed embodiment, undecorated and without an attachment device. The attachment device can be any “finding” (well known Jewelry and Craft term, meaning connecting structure) a manufacturer and or designer may wish. The type of finding, and proportions, determines what it will be used for, and may impact the longitudinal size of the main body 10 illustrated in FIG. 4. The original intent is for a temporary eye glass resting spot in a functional and aesthetically pleasing format, for both men and women.

FIG. 6 illustrates a perspective end view of the connection between the decorator bar 1 at the non-latching end of the bar 1a, and the curved end 2a of the main body. This connection is preferably via casting or soldiering.

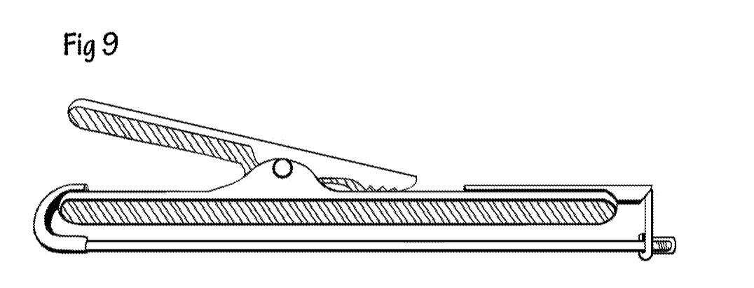

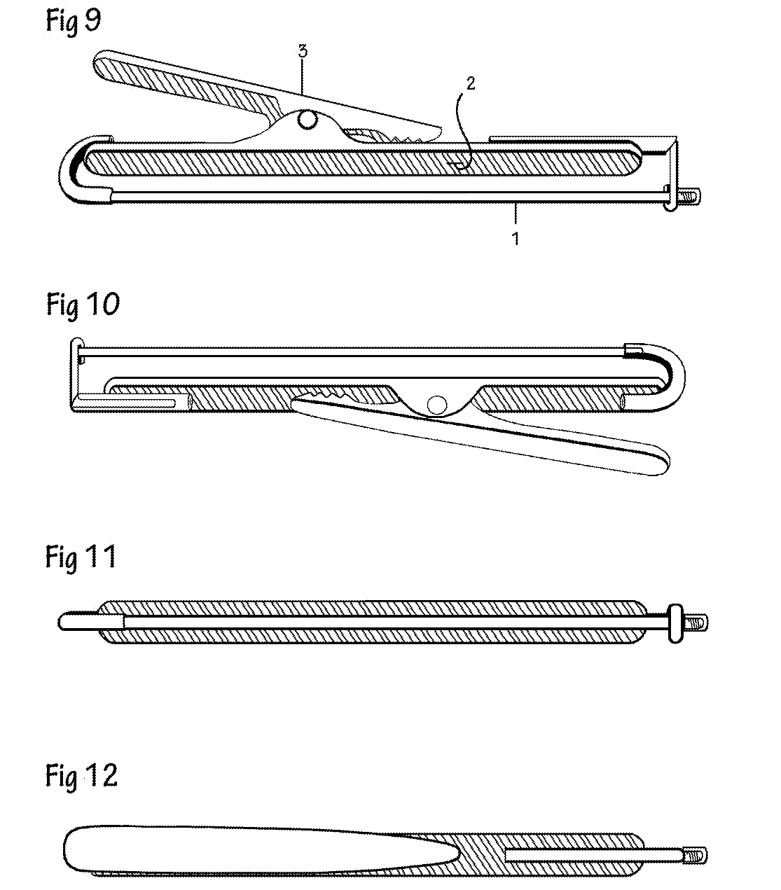

Turning to FIG. 9, there is illustrated an alternate embodiment as compared with FIG. 1. This embodiment includes a shorter clip 3 than that in FIG. 1. It is noted that if a shorter clip is chosen, the tension in the spring 5 must be proportionally greater.

Such clip 3 is appropriate for attaching the garment accessory to an accessory, as compared with wider ties. It is also appropriate for thin ties or Bolo type ties. Proportions on an assembly intended for thin ties would have less material extending beyond the clip. Such a shorter clip 3 is also illustrated in FIGS. 24 and 25, which includes a shorter main body 10 (base 2, bar 1), to match.

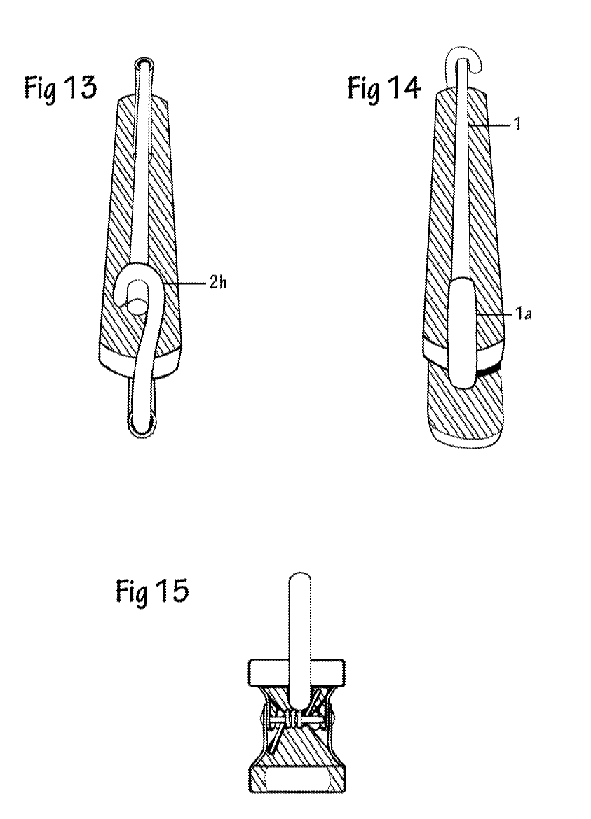

With reference to FIGS. 13-16, an alternative latch mechanism 2m is illustrated. For brevity, reference numbers in these figures which relate to the same structure in the first disclosed embodiment are not reintroduced herein. The free end lb end of the decorator bar 1 and an alternative hook 12b are illustrated. The hook 12b is integral with an elongated member 12, connecting the hook 12b to the bottom side 2d of the base member 2.

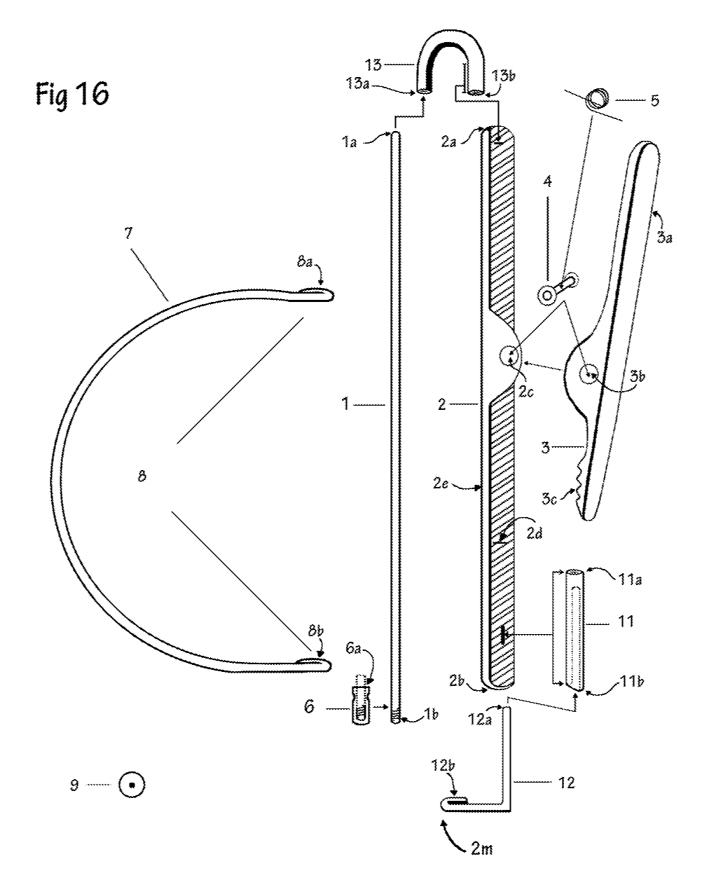

FIG. 14 is a perspective end view, illustrating the decorator bar 1 at the non-latching end la, opposing the latching mechanism 2m. (See also FIG. 16, the exploded view of this embodiment.) The rod forming the decorator bar 1, is run through the finger-grip reinforcement tube 13, before the return curvature is introduced between opposing ends 13a/13b. Once the rod 1 is completely within the tube, the return curve is added to the tube 13, locking the rod 1 in place. Alternatively or in addition, the two can be soldered together. Then bottom of the tube 13b is soldiered to the non-latching end of the base 2a, on the back side 2d.

On the latching end 2b, the latching mechanism includes a tube 11 with opposing ends 11a and 11b, where end 11b receives the end 12a of the elongated member 12 forming the latch arm/hook 12b, which can be soldered therein. The end 12a of the elongated member 12 runs parallel with the longitudinal axis of the base member 2, inside Tube 11, which is soldered to the back face of 2, on the 2d side and then turns substantially perpendicularly thereto so that the hook 12b extends above the front face 2e of the base member 2. It is to be appreciated that the length of the gripping member 3c must be selected to accommodate the span of the tube 11 and does not extend past the end of the tube 11a towards the latching end 2b of the main body 10.

The ends 8a/8b of the loop 7 in this embodiment are looped. For example, the ends 8a/8b of the rod which forms the loop 8 is curled into circles by, e.g., round nose pliers or other tool, so the loop can slide onto decorator bar 1 like a bead. This configuration of the loop 7 is equally applicable to the first disclosed embodiment.

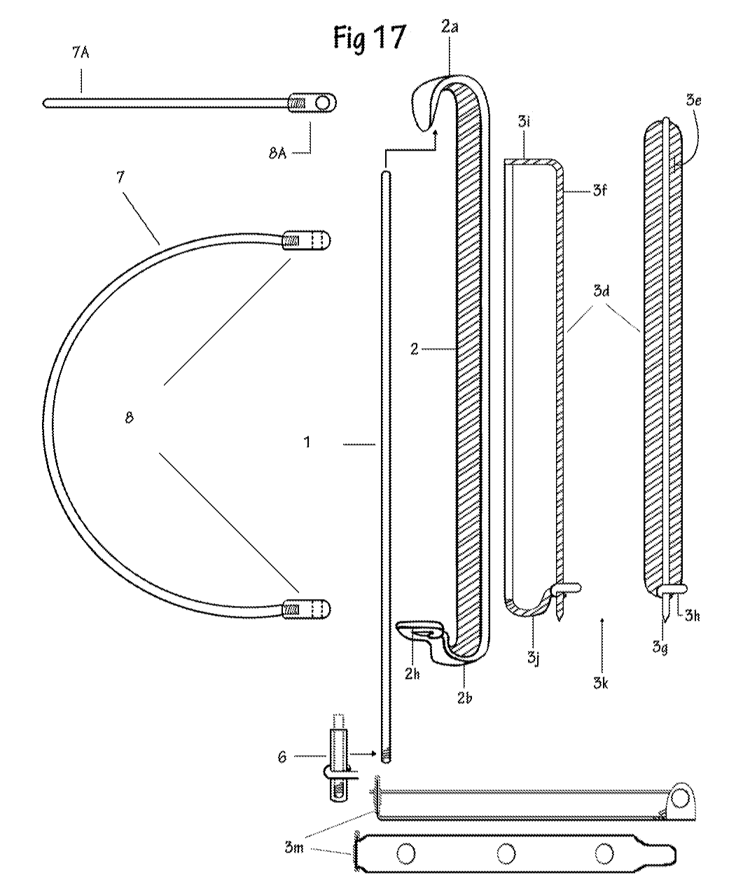

Turning to the embodiment illustrated in FIG. 17, this embodiment is similar to the first embodiment except for the alternative finding. That is, the main difference is in the clip 3. In this embodiment the clip 3, serving as an attachment device 3k, is a brooch finding. Two types are depicted but the garment accessory is not limited to them.

The first type 3d is a custom type brooch finding, which has a design similar to the main body 10 itself, with its own base 3e and connecting bar 3f, which has a free end 3g for piercing clothing. The free end 3g is held in place by a hook member 3h, similar to hook member 2h. The opposing ends of the bar 3i, 3j, connect with the base 3e without requiring the opposing C-channels. Instead the ends can extend from the base in the form of wires, either perpendicularly therefrom 3i or in a curved manner 3j, and can be formed integrally therewith.

In comparison, the second type 3m is an “off the shelf” type bought in any craft store or finding store. There are all kinds and any one, of sufficient strength and size are acceptable substitutes. This embodiment is preferable for scarves to be offset from the center, but still attached to a blouse or shirt. It can still be used for ties or alone.

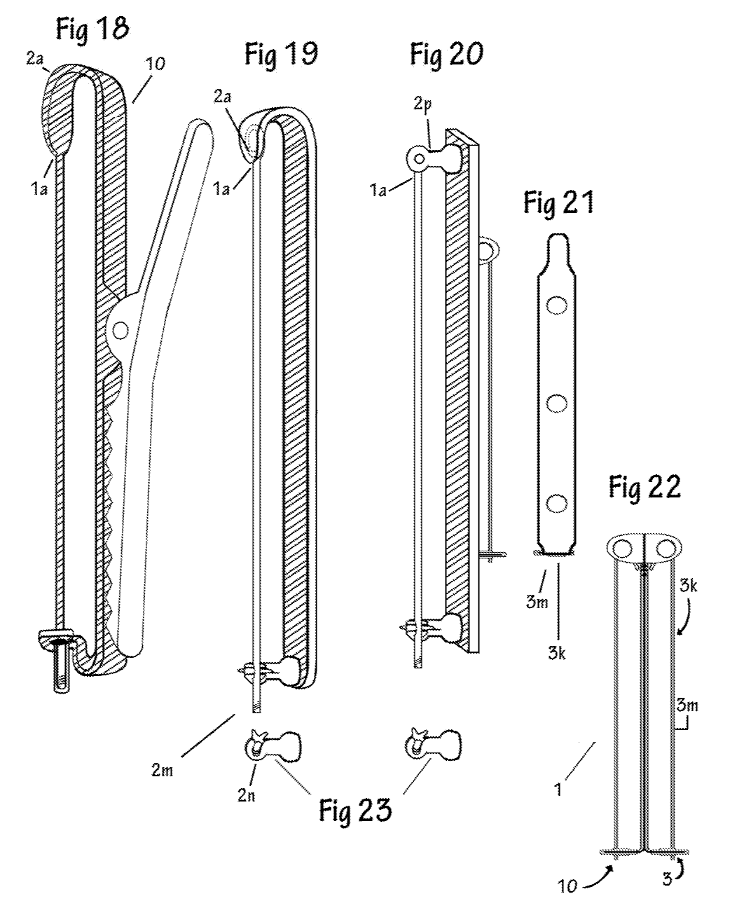

FIGS. 18-22 illustrate alternatives in the manufacturing process.

Attention is now directed to FIG. 18. Non-latch sides ends of the decorator bar and base 1a, 2a are separate in FIGS. 1. In FIG. 18, these pieces are unitary. The pieces are, for example, constructed in wax, then a mold made of it and then cast. All of the shaded areas are one piece, i.e., the main body 10.

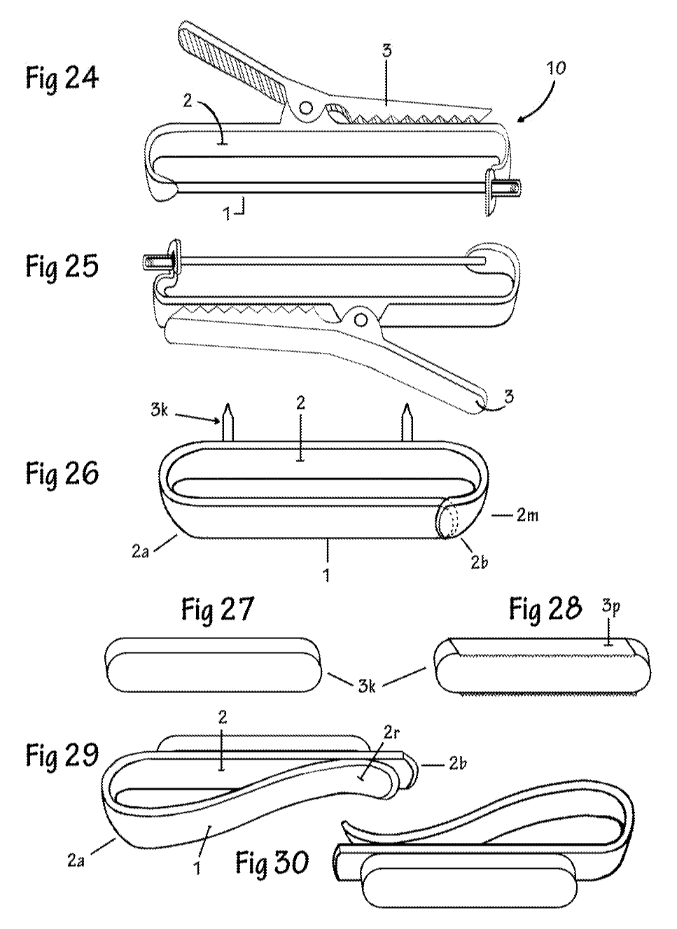

FIG. 19 illustrates only the main body 10. The clip 3 is not drawn but is assumed present as needed. In this embodiment, a strengthening soldier technique connects the decoration bar with the base at the non-latch end 1a, 2a. On the opposing end 2b, the latch mechanism 2m includes in place of a hook 2h, an “Off the Shelf” brooch latch or breast pin latch 2n, illustrated in FIG. 23.

FIG. 20 illustrates a flat, planar form of the base 2 and the decorator bar 1 at its non-latch end 1a is attached to the non-latch end 2a of the base 3 via a brooch or breast pin findings 2p. As with FIG. 17, an “off the shelf” brooch or breast pin 3m serves as the attachment device in place of the toothed clip 3. A bottom side of the pin 3m is illustrated in FIG. 21.

FIG. 22 illustrates a simplified version of the brooch embodiment. The main body 10 and the clip 3 are both replaced by brooch pins, connected bottom to bottom with the one serving as the main body 10 including the decoration bar 1 and the pin 3m serving as the attachment device. The loop 7 (not illustrated) fulfills the function as an eyeglass holder.

FIGS. 24-30 illustrates non-limiting alternative embodiments. FIGS. 26, 29 and 30 are embodiments that are aesthetically pleasing and functional, and use may be without additional ornamentation such as beads. These embodiments do still function as eyeglasses holders, with or with out decoration.

FIGS. 24 and 25, referenced above, provide a similar embodiment to FIG. 1, with shortened proportions of the entire assembly to be used as a tie bar for skinny ties or a smaller scarf clip. The alligator style attachment device 3 may be replaced with any other style attachment device, such as a brooch pin findings/tie tack pins, scatter pins, magnets, button hole style, etc.

FIG. 26 provides a modified base 2, in which the C-channel at end 2a continues to extend along the longitudinal direction of the base 2 until it reaches the opposing end 2b, with little or no variation in width, so as to form the decorator bar 1. The function of the latching mechanism 2m is served by the C-channel on the latch-side 2b, which terminates at a point where opposing ends of the base 2a, 2b overlap. A hook portion 2h is not provided in this embodiment.

In this embodiment, the decorator bar 1 is pressed to the side and under the shorter side 2b, to latch. Reversing this operation to unlatches the structure. A decoration is slid on in the unlatched state. A decoration is created with a slotted hole instead of a round hole so as to conform with the shape of the decorator bar 1. This embodiment is especially good for clay and cast decorations that require more stability with no turning and twisting of the decoration.

In this embodiment, oval jump rings may be used to add charms and other objects to the decoration bar 1 as well. O-rings (relatively larger ones) can be used to hold a decoration in a specific place. This embodiment is suitable for keeping a Bolo or skinny tie close to the body and suitable for a jacket pin when wearing a suit and the tie bar is not available for use for hanging glasses. In this embodiment, the attachment device. 3k is a tie tack or scatter pin findings.

FIG. 27 illustrates an alternative attachment device 3k, which is a back or attaching magnet to be used as the chest side of a magnet finding. A magnet may be desired where the item is to be used in a machine shop or manufacturing work environment, where hanging glasses are forgotten on the device and could get caught in equipment, potentially, causing an accident related injury, here the magnets would separate and the glasses and holder take the damage and not the worker. A conventional magnet might break apart if caught on something, possibly increasing the potential to losing one's glasses inadvertently. For some, the convenience and functionality of the device may outweigh the risks. This embodiment is also suitable for fine or sheer fabrics where a pin hole is damaging. The thinner the fabric the better the hold. This configuration is less suitable for loose or draped attire that has no support for something as weighty as glasses.

FIG. 28 illustrates a further modified attachment device 3k illustrated in FIG. 27, where a grip shield 3p is provided to help a back/attaching magnet stay in contact with the finding/receiving magnet thru the fabric of a shirt. The receiving magnet does not get the grip shield, as it sits inside the lip of the grip shield on the attaching magnet.

FIGS. 29 and 30 illustrate an embodiment similar to that disclosed in FIG. 26, above. The base only has a single C-channel, at the non-latching end 2a, and the other end of the base 2b terminates in line with the remainder of the base 2. The decoration bar 1, instead of going directly/linearly across the front, in this embodiment, curves inward toward the base 2 and ends at 1b just shy of the end of the base 2b with a slight upward tilt, away from the base 2b, providing a spring biased contact point 2r . The latching mechanism is the spring action of the work hardened metal.

In this embodiment, a decoration is slid on via moving the front open end, up away from the base 2, enough to accept the object. As with the embodiment illustrated in FIG. 26, the decoration utilizes a slotted hole instead of a round hole, oval jump rings may be used to add charms and other objects to the decoration bar 1 as well, and larger o-rings can be used to hold a decoration in a specific place or from working it's way off.

Furthermore, these figures also illustrate the magnet finding as the attachment structure 3k. One magnet is on the back of the base 2 and the other matching magnet is on back of the fabric (not shown), sandwiching the fabric between the two magnets. The magnets should be strong enough to hold the device, decoration and glasses in place.

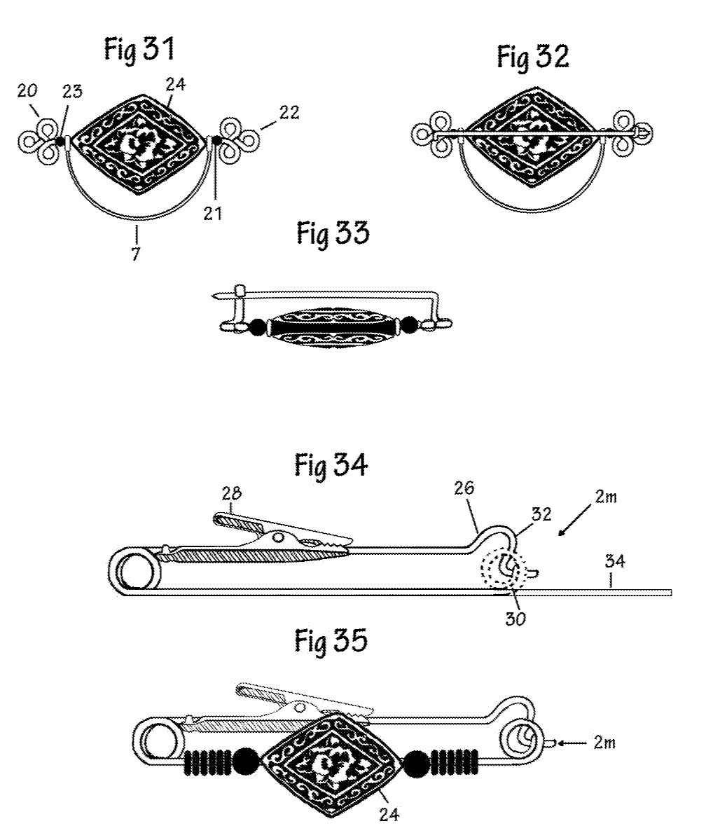

FIG. 31 illustrates a brooch that utilizes the loop 7 as the eye glass holder. One of opposing ornamental end pieces 20, 22 can be removed and a decoration piece 24 is positionable there between. The decoration can be, e.g., a large carved wood bead center piece, including a small bead 21, 23 on either side to balance the effect.

FIG. 34 illustrates a wire 26 and alligator clip 28 with no decoration, though decorations may be added along with a loop 7. Such decorations and loop would be put on prior to the forming the coiled latch 30, which receives the hook 32. An extension 34 is illustrated to show an approximate length of the wire 26 required to form the loop 30. This latching mechanism 2m is a free form style. In FIG. 35, the embodiment of FIG. 34 includes a decoration 24. The decoration 24 was put on prior to the latch being formed.

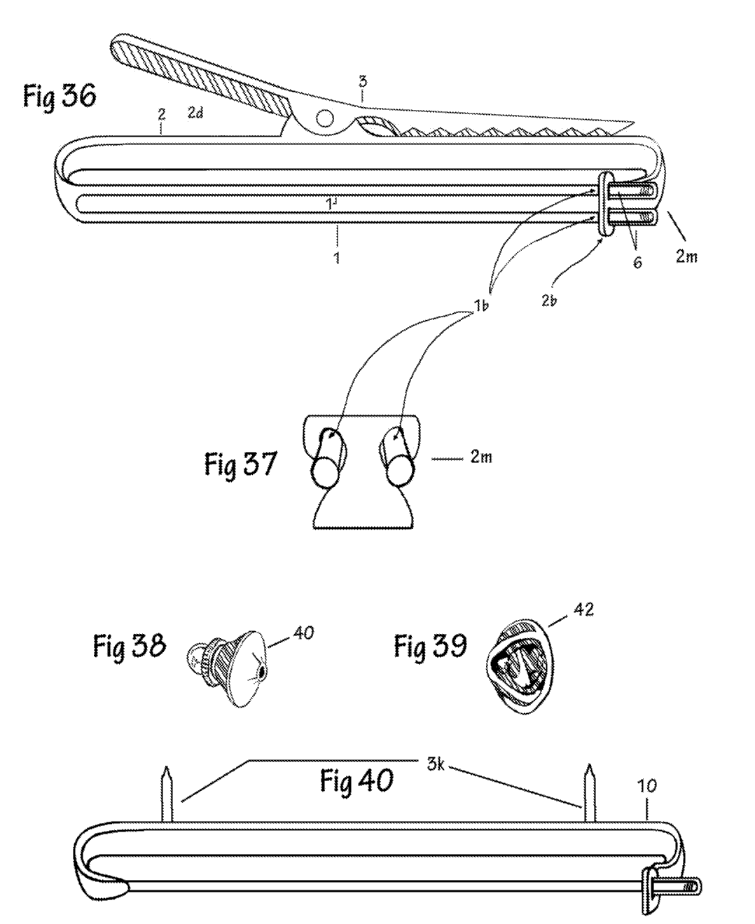

FIG. 36 illustrates a double decorator bar 1 configuration with an appropriate latching mechanism 2m, which is essentially a dual latch at the latch end of the bar and base 1a, 2b of the type illustrated in FIG. 1. FIG. 37 is a close-up of the dual latch mechanism 2m. FIG. 40 illustrates the main body 10 of FIG. 1, with an attachment means 3k comprising a posts for a tie tack and/or scatter pin. FIG. 38 illustrates a tie tack back 40 and FIG. 39 illustrates a scatter pin back 42.

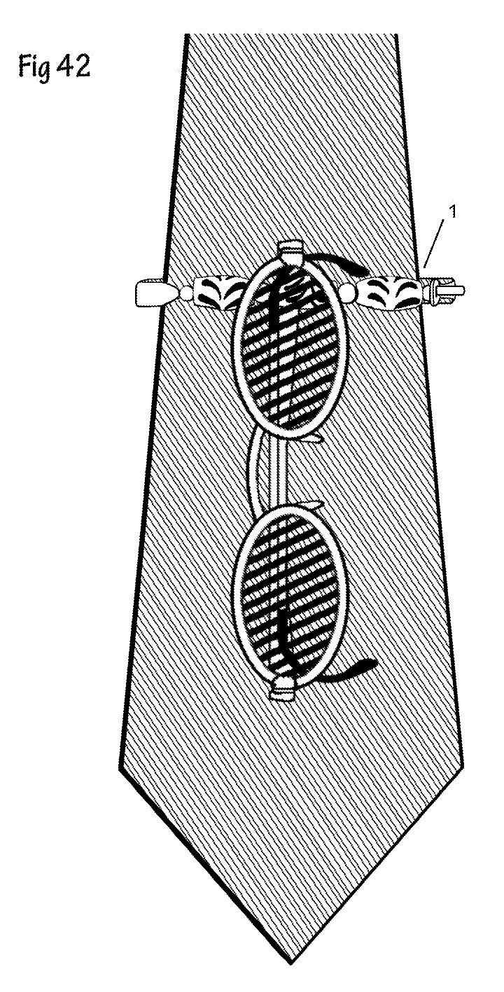

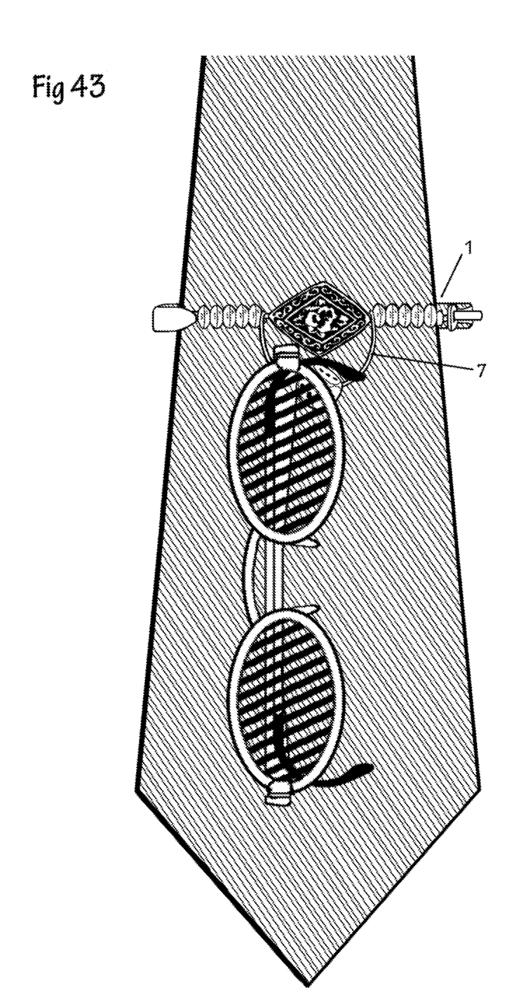

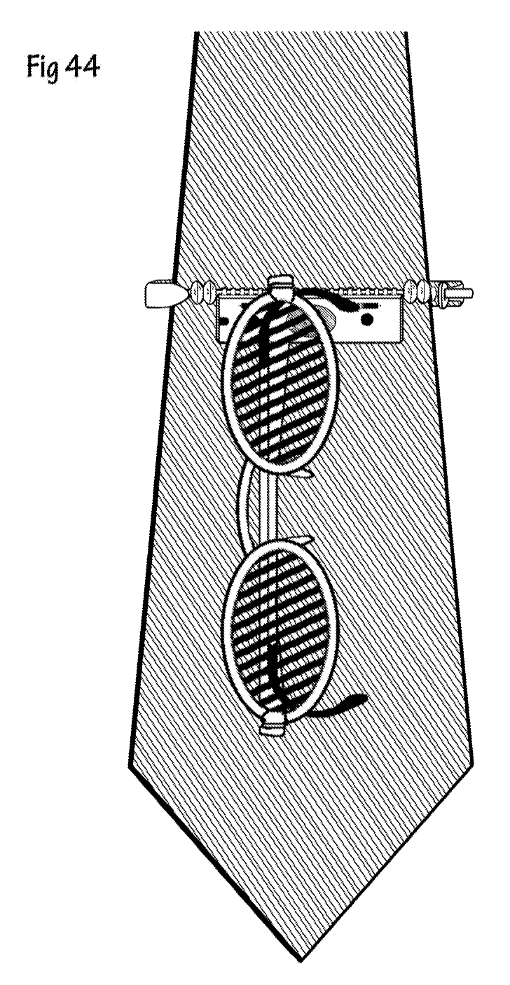

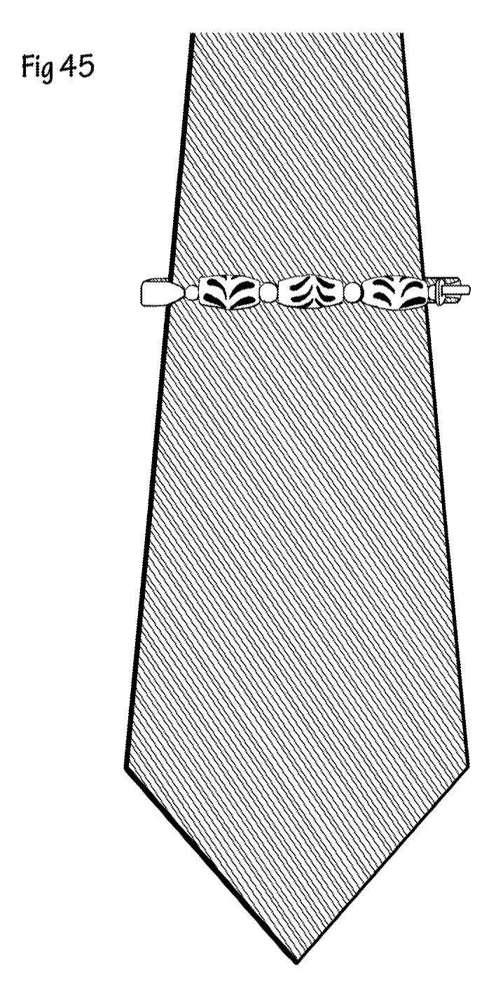

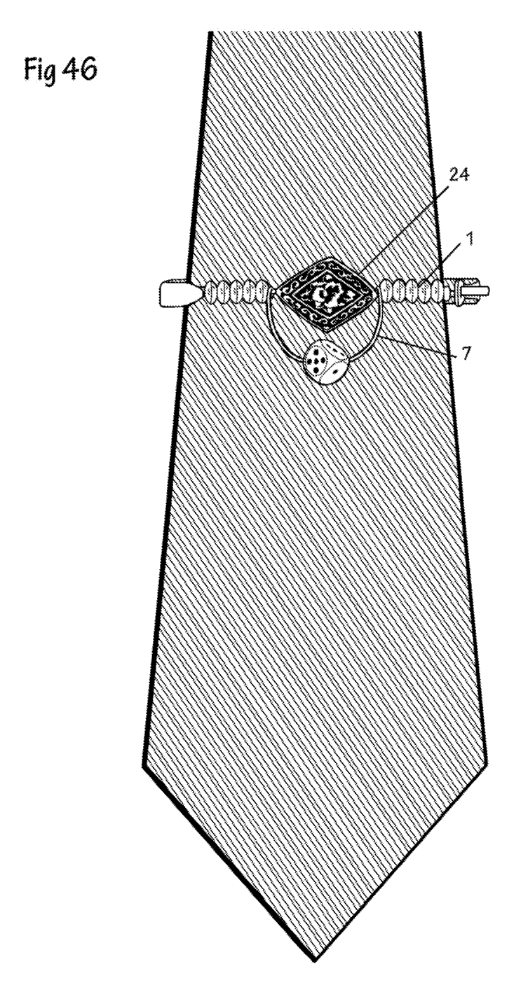

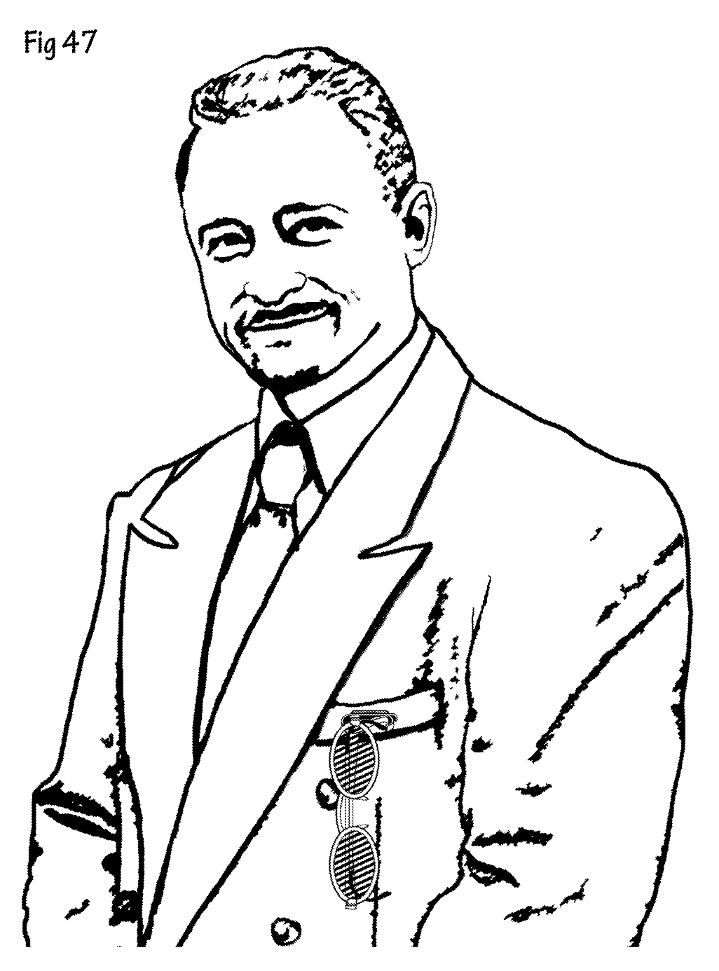

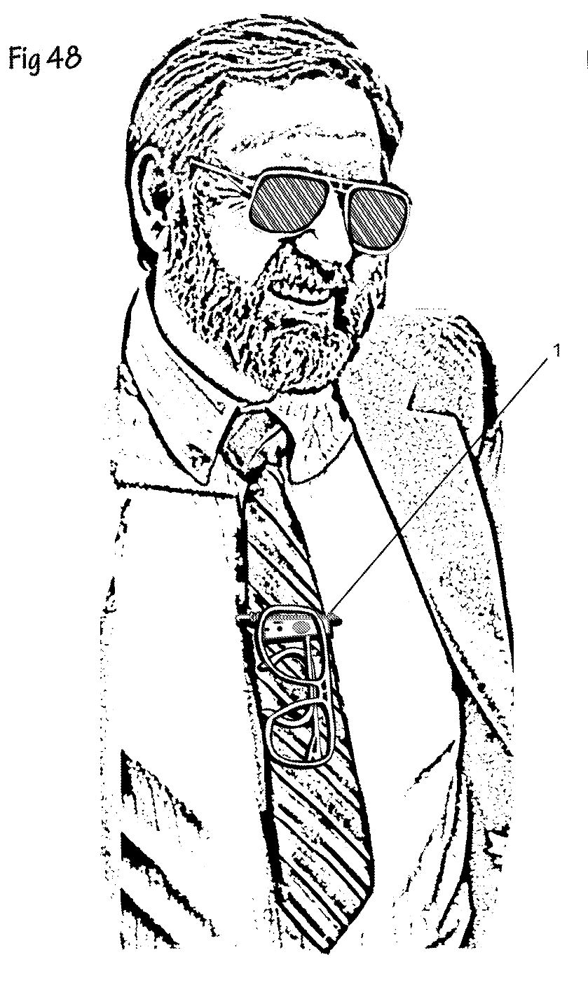

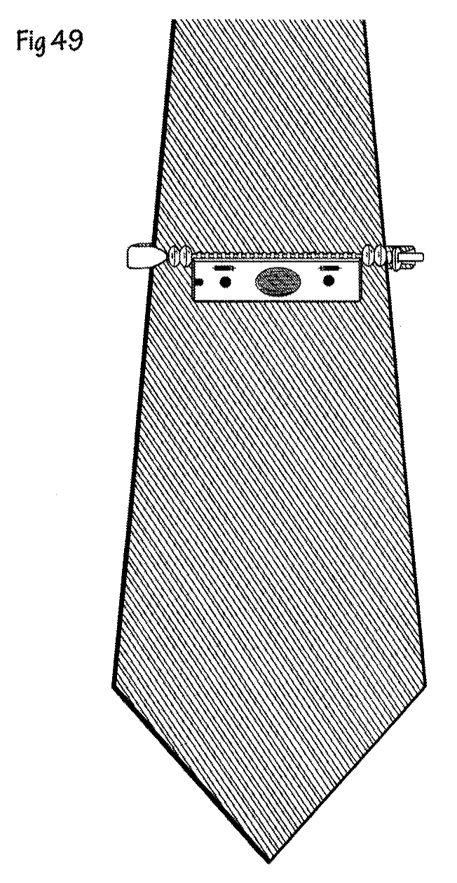

FIG. 41 is a view of the embodiment of FIG. 1, from the inside out. FIG. 42 is a view of the embodiment of FIG. 1, with the decoration bar 1 decorated with glasses hanging. FIG. 43 is a view of the embodiment of FIG. 1 with the decoration bar 1 including with glasses hanging on a loop 7. FIG. 44 is a view of the embodiment of FIG. 1 with the decoration bar 1 including glasses hanging. FIG. 45 is a view of the embodiment of FIG. 1 with the decoration bar 1 without glasses. FIG. 46 is a view of the embodiment of FIG. 1 with the decoration bar 1 with a loop 7, a decoration piece 24 and without glasses. FIG. 47 is a view of the embodiment of FIG. 29 with glasses, in use. FIG. 48 is a view of the embodiment of FIG. 1 with the decoration bar 1 with glasses, in use. FIG. 49 is a view of the embodiment of FIG. 1 with the decoration bar 1 without glasses.

For each of the above designs, the material can be any metal, e.g., a low end product can be lower end metals, which can be then plated with a finer metal. A high end product can be a precious metal, e.g., gold or silver.

The above disclosed framework is almost completely changeable as to what is installed on it. One configuration has stars dangling from it, another includes a different style of beads or bead work.

The disclosed embodiments can be used by anyone. A kit for a user is within the scope of the invention, to be utilized with any of the series of frameworks. Themes such as movies promotional or fan memorabilia, sports team logos and memorabilia, business logos, favorite animals, teen themes, etc.

While one purpose is a customizable eye glass holders and tie bar, another use is for securing scarves. The main body can secure different clothing or accessory devices. The disclosed embodiment is a customizable eye glass holder framework, an accessory confinement device and clothing adornment device/jewelry.

The present invention may be embodied in other specific forms without departing from its spirit or essential characteristics. The described embodiments are to be considered in all respects only as illustrative and not as restrictive. The scope of the invention is, therefore, indicated by the appended claims and their combination in whole or in part rather than by the foregoing description. All changes that come within the meaning and range of equivalency of the claims are to be embraced within their scope.

1. A garment accessory comprising:
a base;
an attachment structure for attaching the base to a garment; and
a supporting structure connected to the base for supporting one or more of ornamentation, eyewear, and additional supporting structure for supporting eyewear.

2. The accessory of claim 1, wherein the attachment structure is an alligator clip.

3. The accessory of claim 1, wherein the attachment structure is a pin and tack.

4. The accessory of claim 1, wherein the attachment structure is a magnet.

5. The accessory of claim 2, wherein the base has a longitudinal dimension and the clip has a longitudinal dimension which is essentially the same as the base.

6. The accessory of claim 2, wherein the base has a longitudinal dimension and the clip has a longitudinal dimension which is substantially less than the base.

7. The accessory of claim 1, wherein the and the base and supporting structure each have parallel extending longitudinal axises;
at a first end of the axises, the base and supporting structure are permanently connected via a first end connecting structure; and
at a second end of the axises, the base and supporting structure have ends which are releasably connected to each other.

8. The accessory of claim 7, wherein the supporting structure is a bar;
said first end of the axises is a latch-free end; and
said second end of the axises includes a latch mechanism for releasably latching the bar to the base.

9. The accessory of claim 8, wherein the latch mechanism includes a hook connected to the base by a second end connecting structure.

10. The accessory of claim 9, wherein the first and second end connecting structures are C-channels.

11. The accessory of claim 10, wherein the first and second end connecting structures are unitary with the base.

12. The accessory of claim 9, wherein the second end connecting structure extends perpendicularly to the longitudinal axis for the base.

13. The accessory of claim 9, wherein the bar supports the additional supporting structure, which is a loop connected at opposing ends to the bar.

14. The accessory of claim 13, wherein the opposing loop ends have eyelets for slipping over the bar.

15. The accessory of claim 14, where the eyelets and loop are a unitary structure.

16. The accessory of claim 7, wherein the base and supporting structure have a substantially constant width.

17. The accessory of claim 16, wherein the supporting structure intersects substantially at a free edge with the base, the free edge being spring biased towards said base.

18. The accessory of claim 8, wherein said bar and base are a unitary wire member.

19. The accessory of claim 8, wherein the supporting structure includes plural bars extending parallel with each other and said latch mechanism is adapted for releasably securing said plural bars.

20. A kit including the accessory of claim 1 and one or more ornamental items, each including an orifice so that said one or more ornamental items is adapted for sliding over the supporting structure and being removably positioned thereon.
